(19) United States
(12) Patent Application Publication
(10) Pub. No.: US 2007/0096673 A1
(43) Pub. Date: May 3, 2007

(54) Robot arm and robot support structure

(75) Inventor: Ulrich Hagn, Paehl (DE)

Correspondence Address: CLEMENTS WALKER, 1901 ROXBOROUGH ROAD, SUITE 300, CHARLOTTE, NC, 28211, US

(73) Assignee: Deutsches Zentrum fuer Luft- Und Raumfahrt e.V.

(21) Appl. No.: 11/591,805

(22) Filed: Nov. 2, 2006

(30) Foreign Application Priority Data
Nov. 3, 2005 (DE) 10 2005 052 443.5

(51) Int. Cl. B25J 5/00

(52) U.S. Cl. 318/568.12

(57) ABSTRACT

A robot arm comprises a plurality of joints (10) which are connected to each other by connection elements (12). The connection elements (12) carry heat-generating components (14), particularly electronic components comprising thermally critical parts. For cooling these components, at least one connection element (12) comprises a heat-dissipating element made from a ceramic material. Preferably, the whole connection element (12) is made from a ceramic material. Due to their low thermal expansion coefficient and their good thermal conductivity, ceramic materials offer considerable advantages in comparison with support structures made of aluminum.

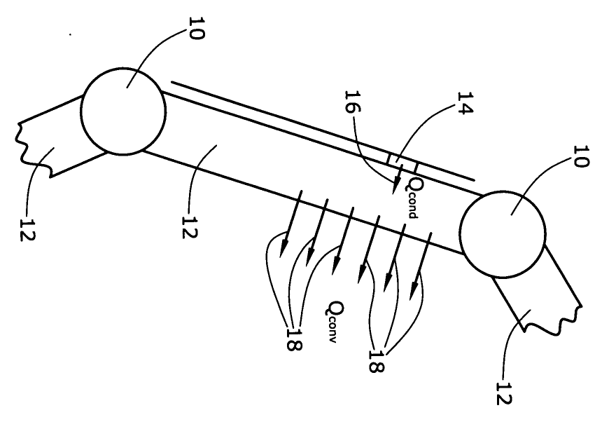

The present invention relates to a robot arm and a robot support structure.

### BACKGROUND OF THE INVENTION

Robot arms comprise a plurality of articulated joints which are connected to each other via connection elements and support structures, respectively. The controlling of these joints and/or of a manipulating means connected to the robot arm, e.g. a robot hand, so as to define the position of the robot arm, and/or the controlling of individual components of the robot arm etc. requires a large number of components, particularly electric and electronic components. Examples of such components are actuator or drive motors, processors, communication electronics, sensors and sensor evaluation electronics, power supply units, power conversion electronics etc. These primarily electric and electronic components generate waste heat. Particularly in thermally critical components such as e.g. processors, power transistors etc., this waste heat has to be dissipated so that the correct functioning of the components can be guaranteed.

A known approach for this purpose resides in arranging the largest possible number of such electronics components and, respectively, thermally critical components in a separate switching cabinet since, when arranged therein, the components can be cooled in a simple manner.

Arranging such components separately from the robot arm makes it possible to reduce the introduction of heat from these components into the connection elements or support structures. This heat reduction is imperative because the connection elements are normally produced from aluminum or a composite material so that an introduction of heat would cause a thermal expansion with a resultant impairment of the system accuracy and the functional precision of the robot arm, respectively.

Placing components into a separate switching cabinet is, however, partially bothersome and complicated because of the resulting necessity to install connectors, electrical connection lines and the like. Therefore, efforts are under way to integrate all of the electric and electronic components into the robot arm so as to obviate the need for a switching cabinet. For this purpose, DE 100 33 224 proposes to arrange the drive electronics, which are distributed on the robot arm, with thermal insulation from the connection elements and the support structures, respectively, and to provide each of them with a dedicated cooling means. For effective dissipation of heat by means of such cooling bodies, the cooling bodies must have a volume suited to effect a fast heat absorption from the critical components. Further, for heat dissipation by convection, the cooling bodies must have a large surface area. As a consequence, the cooling bodies have a relatively large volume and thus also a relatively large mass. This results in an increase of the net weight of the robot arm. Especially in the upper segments of the robot arm, i.e. in the segments carrying e.g. the robot hand or a handling device, this entails the effect that the load-carrying capacity of the robot arm is reduced. Further, during movements of the robot arm, the existence of additional mass has adverse influences caused by the occurring moments of inertia. Also in cooling systems where the heat dissipation is performed with the aid of fluids, it is disadvantageous that the fluids, to be able to safeguard a sufficient cooling of the corresponding components, must have a sufficient heat capacity and thus a corresponding volume. Also this causes an increase of the mass of the robot arm, leading to the disadvantages described above.

It is an object of the invention to provide a robot arm and a robot support structure which are suited to carry heat-generating components while providing sufficient heat dissipation.

### SUMMARY OF THE INVENTION

The above object is achieved by a robot arm according to claim 1 and a robot support structure according to claim 9, respectively.

The robot arm according to the invention comprises a plurality of joints which are connected to each other via connection elements. Particularly, the connection elements are provided as support structures. In the context of the present invention, support structures are to be understood as components which form the weight-carrying structure of the robot arm and serve to take up and transmit forces/moments. Further, the robot arm comprises heat-generating components, e.g. electric and electronic components, which are carried by the connection elements. According to the invention, at least one connection element comprises a heat dissipation element containing a ceramic material. Preferably, the heat dissipation element is connected to the component which is to be cooled. Particularly, this connection is to the largest possible extent a direct connection between the heat dissipating element and the component to be cooled. The provision of a heat dissipating element which includes a ceramic material and particularly is made from a ceramic material will offer the advantage that such an element has a good thermal conductivity so that the heat can be dissipated from the to-be-cooled component in a simple manner. A further advantage of the ceramic material resides in its considerably lower thermal expansion coefficient as compared to the materials presently used in the manufacture of robot support structures. In comparison to the normally used aluminum, the thermal expansion coefficient of ceramic is lower by a factor of 5-8. Further, ceramic has good material properties to the effect that ceramic materials can be provided for use in the production of supporting components, i.e. components adapted to transmit forces and moments. Thus, it is also possible to provide the heat dissipating element of the invention as a supporting component of the connection element. This offers the advantage that no separate cooling bodies need be provided which would significantly increase the mass of the robot arm. Instead, by integrating the heat dissipating element into the support structure of the robot arm, a cooling of the corresponding components can be effected, while the weight of the robot arm is increased only slightly at the most.

The disadvantages caused by a provision of additional cooling bodies, as proposed on DE 100 33 224, are thus avoided.

The slightly higher density of ceramic as compared to the normally used aluminum materials can be compensated for by a higher e-module. The differences in stability between ceramic and the normally used materials for robot support structures will not be relevant in robot support structures because robot support structures are designed with particular regard to the aspect of their rigidity and the stability of the structural components will thus be overdimensioned.

Among ceramic materials, particularly pressureless sintered silicon carbides are useful. Further, use can be made of non-oxidic ceramics such as nitrides, borides and suicides. Also oxide ceramics can be used.

According to a particularly preferred embodiment, at least one whole connection element which is arranged between two joints is produced from a ceramic material. The whole connection element will thus serve to take up heat and to effect the cooling of thermally critical components. Further, the surface of the heat dissipating element is thus very large so that the heat can be dissipated in a simple manner by convection. Particularly, all connection elements of the robot arm are made from a ceramic material so that the heat-generating components, particularly the thermally critical components, can be arranged at the largest possible distances from each other. Thereby, mutual interference of these components as caused by heat radiation etc. are avoided.

The heat-generating component can also be connected to the heat-dissipating element by an additionally provided heat conductor.

Further, the invention relates to a robot support structure suited for the connection between robot joints and for supporting exothermic components. According to the invention, the robot support structure and the connection element between two joints, respectively, comprise at least one heat dissipating element which includes a ceramic material and is integrated into the support structure. According to the invention, the heat dissipating element is configured as a supporting component, as mentioned above.

Preferably, the robot support structure of the invention is modified in the manner described above with regard to the robot arm.

A preferred embodiment of the invention will be described in greater detail hereunder with reference to the attached drawing.

### BRIEF DESCRIPTION OF THE DRAWING

The sole FIGURE of the drawing shows a schematic lateral view of a part of the robot arm.

### DETAILED DESCRIPTION OF A PREFERRED EMBODIMENT OF THE INVENTION

Turning now to the embodiment illustrated in the sole FIGURE of the drawing, the FIGURE shows two joints 10 of a robot arm connected to connection elements 12 and robot support structures, respectively.

At least the robot support structure 12 arranged between the two joints 10 is made of a ceramic material. An electronic component 14 is directly connected to the support structure 12 so that a direct thermal coupling exists between the electronic component 14 and the ceramic support structure 12. The amount of heat Q_{cond} generated by the electronic component 14 is taken up, as schematically indicated by arrow 16, by the ceramic structure 12 having good thermal conductivity. The heat dissipation takes place by convection Q_{conv} indicted by arrows 18.

Since at least the robot support structure 12 which is arranged between the two joints 10 is produced completely from a ceramic material, the need to provide additional masses in the form of cooling bodies, or cooling ducts and cooling fluid, is eliminated.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A robot arm, comprising:
a plurality of joints (10),
connection elements (12) arranged between the joints (10), and
heat-generating components (14) supported by the connection elements (12),
wherein
at least one connection element (12) comprises a heat-dissipating element including a ceramic material, said element being a supporting component of the connection element (12).

2. The robot arm according to claim 1 wherein the heat-dissipating element is made substantially of a ceramic material.

3. The robot arm according to claim 1 wherein at least one complete connection element (12) arranged between two joints (10) is made of a ceramic material and thus forms the heat-dissipating element (12).

4. The robot arm according to claim 1 wherein all connection elements (12) are provided as heat-dissipating elements (12).

5. The robot arm according to claim 1 wherein the connection elements (12) are configured as the support structure of the robot arm.

6. The robot arm according to claim 1 wherein adjacent joints (10) are connected to each other exclusively via a connection element (12).

7. The robot arm according to claim 1 wherein the components (14) comprise electric and/or electronic components which particularly include thermally critical components.

8. The robot arm according to claim 1 wherein the heat-dissipating element (12) is connected to the component (14) in a manner allowing for heat dissipation.

9. A robot arm support structure for mutual connection of robot joints (10) and for accommodating heat-generating components (14) wherein at least one heat-dissipating element (12) comprising a ceramic material is integrated into the support structure.

10. The robot arm support structure according to claim 9 wherein the heat-dissipating element (12) is made substantially of a ceramic material.

11. The robot arm support structure according to claim 9 wherein the heat-dissipating element is a supporting component of the connection element (12).

12. The robot arm support structure according to claim 9 wherein at least one complete connection element (12) arranged between two joints (10) is made of a ceramic material and thus forms the heat-dissipating element (12).
